(19) United States
(12) Patent Application Publication
(10) Pub. No.: US 2026/0095688 A1
(43) Pub. Date: Apr. 2, 2026

(54) EARMUFF AND HEADPHONE HAVING THE SAME

(71) Applicant: BENQ CORPORATION, Taipei City (TW)

(72) Inventors: Chih-Hung LIN, Taipei City (TW); Shu-Jing CHANG, Taipei City (TW)

(73) Assignee: BENQ CORPORATION, Taipei City (TW)

(21) Appl. No.: 19/324,302

(22) Filed: Sep. 10, 2025

(30) Foreign Application Priority Data
Sep. 30, 2024 (CN) 202411379496.8

(51) Int. Cl. H04R 1/10

(52) U.S. Cl. CPC H04R 1/1008; H04R 1/105

(57) ABSTRACT

An earmuff for a headphone and a headphone having the same are provided. The earmuff comprises a case, an earpad and an adjusting component. The case has at least one locating structure. The earpad is disposed on the case. The adjusting component is disposed between the earpad and the case. The adjusting component comprises at least one adjustable portion and at least one fixed portion. The at least one adjustable portion is correspondingly and movably connected to the at least one locating structure of the case. The at least one fixed portion is fixed with the earpad. By adjusting the adjustable portion, a surrounding shape formed by the adjusting component can be changed, thereby causing the shape of the earpad to change. As such, a purpose of adjusting a listening experience without exchanging the earmuff can be achieved.

This application claims the benefit of People’s Republic of China application Serial No. 202411379496.8, filed on September 30, 2024. The contents of this application are incorporated herein by reference.

### TECHNICAL FIELD

The present invention relates to an earmuff and a headphone having the same, and in particular relates to an adjustable earmuff and a headphone having the same.

### BACKGROUND

In different situations, an earphone user may desire a different listening experience. For headphones, changes in listening experience can currently only be achieved by replacing the earmuffs. However, factors such as the materials of the various layers and foam of the earmuffs, as well as the size of the earmuffs, all affect the listening experience. Therefore, there are too many variables when replacing other earmuffs, making it difficult to adjust in an intuitive manner.

### SUMMARY

The present invention provides an earmuff that can intuitively adjust the listening experience and a headphone having the same.

An earmuff of a headphone according to the present application comprises a case, an earpad and an adjusting component. The case has at least one locating structure. The earpad is disposed on the case. The adjusting component is disposed between the earpad and the case. The adjusting component comprises at least one adjustable portion and at least one fixed portion. The at least one adjustable portion is correspondingly and movably disposed on the at least one locating structure of the case. The the at least one fixed portion is fixed to the earpad.

An headphone according to the present application comprises two earmuffs according to the present application and a headband. The headband is connected with the two earmuffs.

Comparing the earmuff of the headphone and the headphone having the same provided by the present invention with the prior art, the earmuff of the headphone comprises a case, an earpad and an adjusting component. The case has at least one locating structure. The earpad is disposed on the case. The adjusting component is disposed between the earpad and the case. The adjusting component comprises at least one adjustable portion and at least one fixed portion. The at least one adjustable portion is correspondingly and movably disposed on the at least one locating structure of the case. The at least one fixed portion is fixed to the earpad. By adjusting the adjustable portion, the circumferential shape formed by the adjusting component can be changed, thereby driving a change in the shape of the earpad, so as to achieve the purpose of adjusting the listening experience without replacing the earmuff.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary headphone according to the present invention.

FIGS. 2A to 2F are schematic diagrams of an exemplary earmuff according to the present invention.

FIG. 3 is a schematic diagram of another exemplary earmuff according to the present invention.

FIG. 4 is a schematic diagram of yet another exemplary earmuff according to the present invention.

FIG. 5 is a schematic diagram of still another exemplary earmuff according to the present invention.

### DETAILED DESCRIPTION

The following provides a more detailed description of various embodiments with reference to the accompanying drawings. The descriptions and drawings are provided for illustrative purposes only and are not intended to limit. For clarity, components may not be drawn to scale. In addition, certain components and/or symbols may be omitted in some drawings. It is to be expected that components and features in one embodiment may advantageously be incorporated into another embodiment without further elaboration.

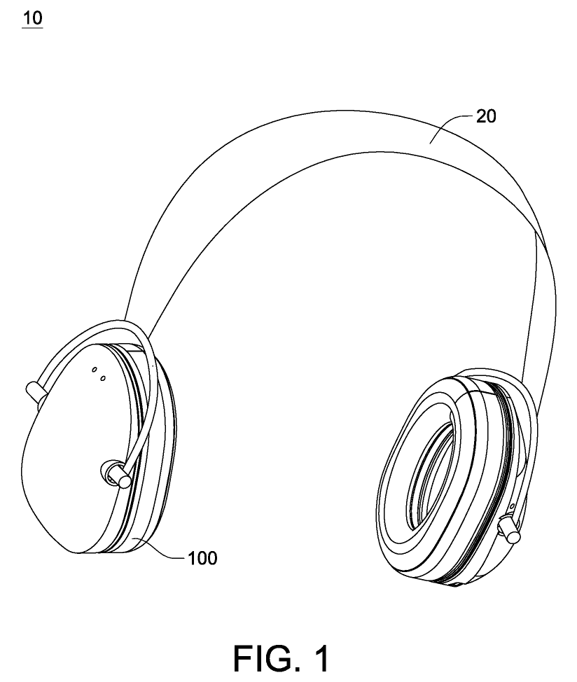

Please refer to FIG. 1, which illustrates an exemplary headphone 10 according to the present invention. The headphone 10 includes two earmuffs 100 and a headband 20. The headband 20 is connected with the two earmuffs 100.

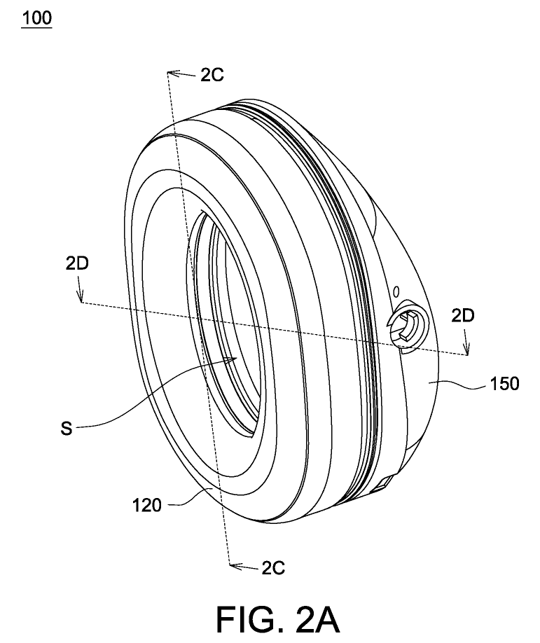

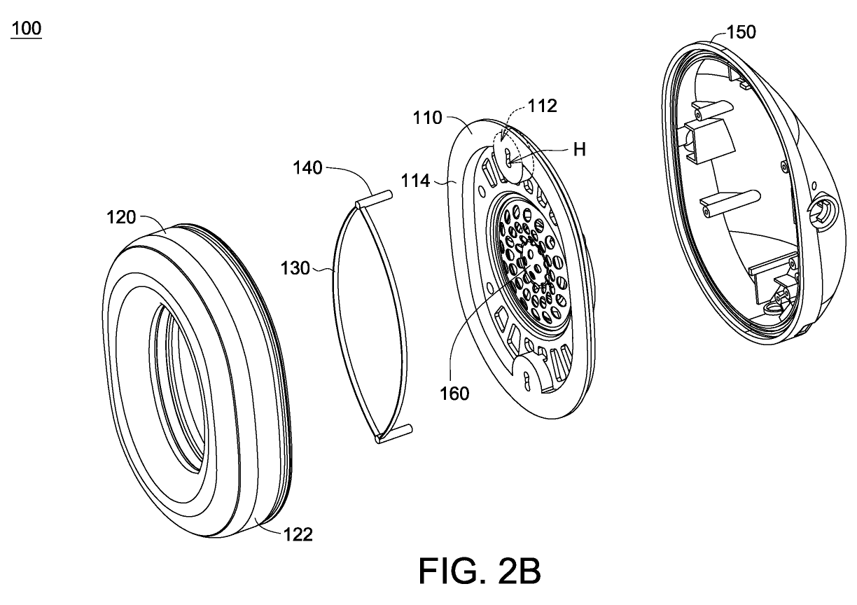

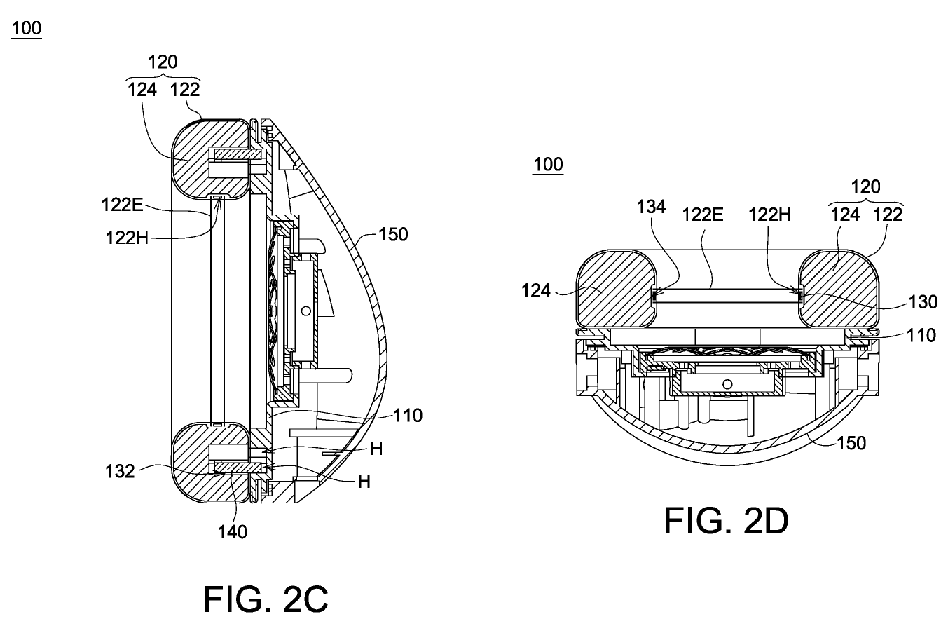

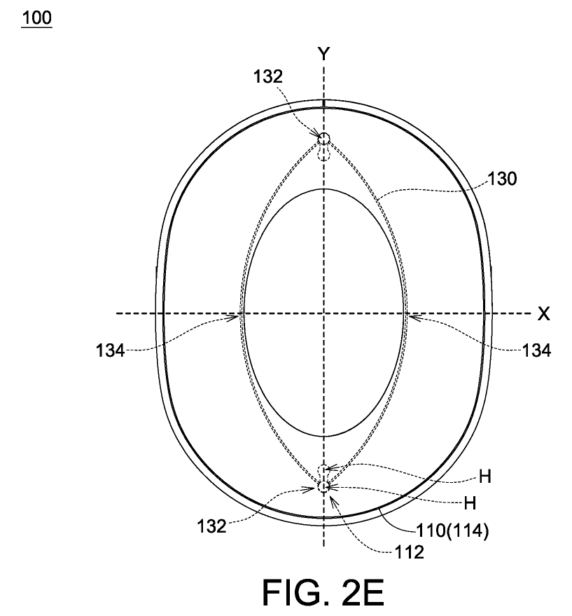

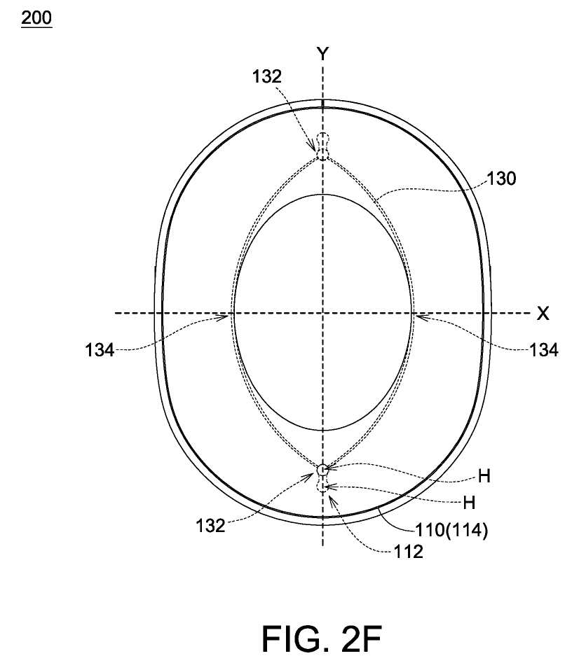

Please refer to FIGS. 2A to 2F, which illustrate details of the earmuff 100 according to the present invention. The earmuff 100 includes a case 110, an earpad 120 and an adjusting component 130. The case 110 has at least one locating structure 112. The earpad 120 is disposed on the case 110. The adjusting component 130 is disposed between the earpad 120 and the case 110. The adjusting component 130 includes at least one adjustable portion 132 and at least one fixed portion 134. The at least one adjustable portion 132 is correspondingly and movably disposed on the at least one locating structure 112 of the case 110. The at least one fixed portion 134 is fixed to the earpad 120.

More specifically, the case 110 includes a main body 114. In the example shown in FIGS. 2A to 2F, the locating structure 112 is directly formed on the main body 114. In other words, the case 110 having the locating structure 112 is formed in an integrally molded manner. The number of locating structures 112 may be consistent with the number of adjustable portions 132 of the adjusting component 130. The locating structures 112 correspond one-to-one with the adjustable portions 132.

The earmuff 100 may further include at least one locating pin 140. The locating pin 140 is correspondingly and slidably disposed in the locating structure 112. For example, the at least one adjustable portion 132 of the adjusting component 130 is correspondingly connected to the at least one locating pin 140, that is to say, the adjustable portion 132 of the adjusting component 130 is connected to the locating structure 112 of the case 110 through the locating pin 140. Thus, it is understood that the number of locating pins 140 may be consistent with the numbers of locating structures 112 and adjustable portions 132 of the adjusting component 130, and the locating pins 140 correspond one-to-one with the locating structures 112 and the adjustable portions 132. Each locating pin 140 can be independently slid by a user within the corresponding locating structure 112 by pinching the earpad 120, thereby driving the corresponding adjustable portion 132 and changing the shape of the nearby earpad 120. Each locating structure 112 may include a plurality of locating holes H arranged along a radial direction of the earmuff 100, and the locating pin 140 corresponding to a certain locating structure 112 is disposed in one of the plurality of locating holes H of the locating structure 112 and can move between the locating holes H. In this example, the adjusting component 130 is annular in shape to correspond to the shape of the earpad 120; in this way, the user can arrange the locating pin 140 at a specific one of the locating holes H, or move the locating pin 140 to another one of the locating holes H, thereby fixing or changing the circumferential shape formed by the adjusting component 130, for example, fixing or changing the size of the adjusting component 130 in its radial direction, and correspondingly fixing or changing the shape of the earpad 120. In another embodiment, the adjusting component 130 may also be an arc that conforms to the curvature of the earpad 120 without being fully closed; however, the actual application is not limited thereto.

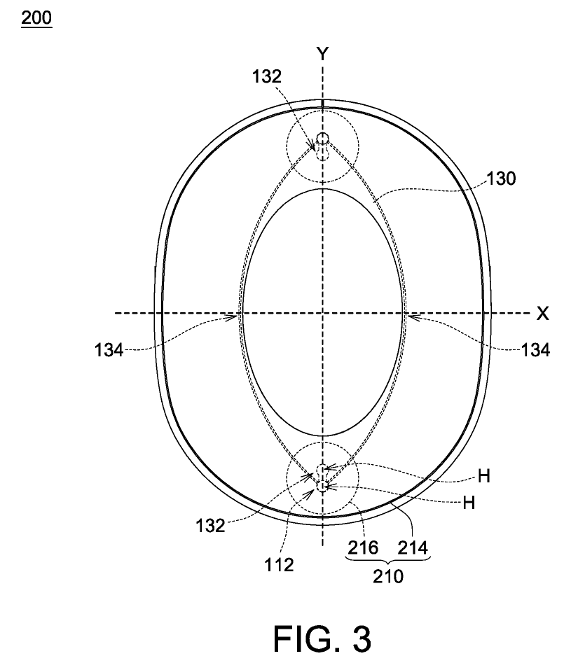

Although in the example shown in FIGS. 2A to 2F, the locating structure 112 is directly formed on the main body 114, the locating structure may also be formed separately from the main body as different components. Please refer to FIG. 3, which illustrates another exemplary earmuff 200. A case 210 includes a main body 214 and at least one locating plate 216. The locating plate 216 is disposed on, for example fastened to, the main body 214. The locating structure 112 is disposed in the locating plate 216. The number of locating plates 216 may be consistent with the number of locating structures 112; that is, the at least one locating structure 112 is correspondingly provided in the at least one locating plate 216. Based on the two examples described above, forming the locating structure 112 integrally on the main body 114, as in the example shown in FIGS. 2A to 2F, is advantageous for simplifying mechanical conduction and enhancing sound quality. Forming the locating structure 112 on the locating plate 216 and then assembling it onto the main body 214, as in FIG. 3, is advantageous for replacing damaged components. The locating plate 216 may be a metal plate, for example a rigid metal plate without flexibility.

Returning to FIGS. 2A to 2F, the earpad 120 may include a cover layer 122 and a filler 124 such as foam. The cover layer 122 and the filler 124 filled therein form a space S with an adjustable volume. The cover layer 122 of the earpad 120 may include an elastic portion 122E disposed along an inner peripheral wall of the earpad 120, wherein the inner peripheral wall of the earpad 120 generally refers to the circumferential inner peripheral wall of the cylindrical portion of the earpad 120. The fixed portion 134 of the adjusting component 130 is fixed to the elastic portion 122E. The elastic portion 122E of the earpad 120 may have a hollow channel 122H; for example, the elastic portion 122E may have a double-layer structure, with the hollow channel 122H formed in a gap of the double-layer structure. At least part of the adjusting component 130 is inserted through the hollow channel 122H; in other words, the adjusting compnent 130 passes through the inner peripheral wall of the earpad 120 located at the elastic portion 122E. More specifically, the fixed portion 134 of the adjusting component 130 is positioned within the hollow channel 122H. Such an arrangement may be achieved through mechanical engagement, but is not limited thereto. The elastic portion 122E may include, for example, elastic leather. Other parts of the cover layer 122 except for the elastic portion 122E may include inelastic artificial leather, but are not limited thereto. In another embodiment, at least part of the adjusting component 130 is connected and disposed on one side of the cover layer 122 adjacent to the elastic portion 122E, wherein the side adjacent to the elastic portion 122E includes at least one of an inner surface and an outer surface of the elastic portion 122E. For example, an annular groove or snap-fit structure for accommodating and fixing the adjusting component 130 may be disposed on the inner surface or outer surface of the elastic portion 122E. This configuration can avoid designing the elastic portion 122E as a hollow type, thereby further reducing manufacturing costs.

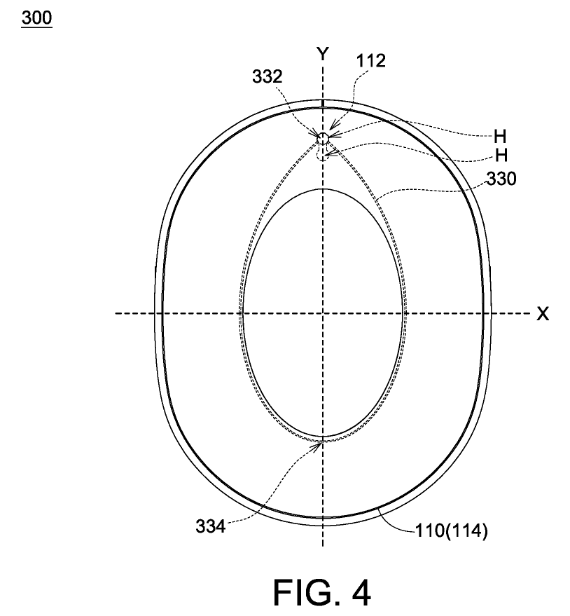

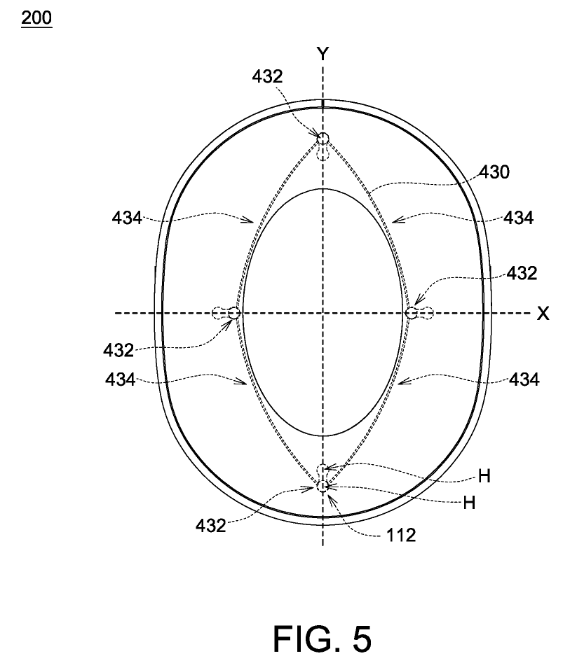

The adjusting component 130 may be flexible. For example, the adjusting component 130 may be formed of a metal sheet. When the adjusting component 130 includes a plurality of adjustable portions 132 and a plurality of fixed portions 134, the adjustable portions 132 and the fixed portions 134 may be alternately arranged. More specifically, the adjustable portions 132 and the fixed portions 134 may be alternately arranged at equal intervals. As shown in FIGS. 2A to 2F, in the earmuff 100, the adjusting component 130 has two adjustable portions 132 and two fixed portions 134, which are alternately arranged. In this case, the two adjustable portions 132 may be disposed on a long axis Y of the earmuff 100, and the two fixed portions 134 may be disposed on a short axis X of the earmuff 100 orthogonal to the long axis Y, as shown in FIGS. 2E to 2F. It is understood that the numbers of the adjustable portions 132 and the fixed portions 134 may be fewer or more than two. For example, in the earmuff 300 shown in FIG. 4, the adjusting component 330 includes one adjustable portion 332 and one fixed portion 334. In the earmuff 400 shown in FIG. 5, the adjusting component 430 includes four adjustable portions 432 and four fixed portions 434.

The entire listening experience adjustment structure, namely the adjusting component 130, the locating pin 140 and the locating structure 112, can be miniaturized and rapidly assembled/disassembled.

According to some embodiments, the earmuff 100 may further include an outer case 150 combined with the case 110. In other embodiments, the outer case 150 may be regarded as another component of the headphone 10 that is not part of the earmuff 100, and is used to be connected with the headband 20 and the earmuff 100. Since the listening-experience adjustment structure of the earmuff 100 is modularly disposed in the portion of the earmuff 100 that does not belong to the outer case 150, the earmuff 100 can be easily and quickly detached and replaced, either detached from the outer case 150 or removed together with the entire outer case 150.

According to some embodiments, the earmuff 100 may further include a sound-generating unit 160 disposed in a space formed between the outer case 150 and the case 110. For example, the sound-generating unit 160 may be assembled in combination with the case 110.

When a user wishes to change the listening experience of the earmuff 100, the user can slide the locating pin 140 from one side of the earpad 120 to another locating hole H, thereby changing the circumferential shape of the adjusting component 130 and causing a change in the volume of the space S of the earpad 120. A smaller volume of the space S provides less spatial sensation and increased treble, while a larger volume of the space S provides more spatial sensation and reduced treble. For example, when changing from the smaller-volume state shown in FIG. 2E to the larger-volume state shown in FIG. 2F, the user may remove the headphone or keep it worn, then move the locating pins 140 inward from the outside so that the two locating pins 140 are moved to the locating holes H closer to the inside. The movement of the locating pins 140 changes the circumferential shape of the adjusting component 130. The flexible adjusting component 130 transmits lateral force, in combination with the outward expansion of the elastic portion, to change the shape and volume of the space S of the earpad 120. When changing from the larger-volume state shown in FIG. 2F to the smaller-volume state shown in FIG. 2E, the user may remove the headphone and slide the locating pins 140 outward so that the two locating pins 140 are moved to the locating holes H closer to the outside. The movement of the locating pins 140 changes the circumferential shape of the adjusting component 130. The flexible adjusting component 130 transmits lateral force, in combination with the inward contraction of the elastic portion, to change the shape and volume of the space S of the earpad 120. Therefore, without replacing the earmuff, the user can intuitively achieve different listening experiences through simple operations.

It is understood that, since each locating pin 140 can slide independently, more adjustment options are possible. For example, only one locating pin 140 in the earmuff 100 may be moved so that the volume of the space S is between the volume of the space S shown in FIG. 2E and the volume of the space S shown in FIG. 2F, resulting in a listening experience between the two. In addition, the number of locating holes H is related to the number of listening-experience adjustment stages available. For example, when each locating structure 112 includes three locating holes H, compared with the case of two locating holes H as shown in the figures, the locating pins 140 have more positions to stay in, giving the user more listening-experience choices and enabling multi-stage adjustment of treble intensity.

Furthermore, since the user slides the locating pins 140 from one side of the earpad 120 and the listening-experience adjustment structure is not exposed, the case 110 and the outer case 150 can be completely sealed to prevent sound leakage.

In summary, the present invention provides an earmuff and a headphone having the same, wherein the earmuff of the headphone includes a case, an earpad and an adjusting component. The case has at least one locating structure. The earpad is disposed on the case. The adjusting component is disposed between the earpad and the case. The adjusting component includes at least one adjustable portion and at least one fixed portion. The at least one adjustable portion is correspondingly and movably disposed in the at least one locating structure of the case. The at least one fixed portion is fixed to the earpad. Through the earmuff of the present invention, the listening experience of a single headphone can be intuitively adjusted by a simple two-dimensional operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An earmuff of a headphone, comprising:
a case having at least one locating structure;
an earpad disposed on the case; and
an adjusting component disposed between the earpad and the case, wherein the adjusting component comprises at least one adjustable portion and at least one fixed portion, the at least one adjustable portion is correspondingly and movably disposed on the at least one locating structure of the case, and the at least one fixed portion is fixed to the earpad.

2. The earmuff of the headphone according to claim 1, further comprising:
at least one locating pin respectively slidably corresponding to the at least one locating structure;
wherein the at least one adjustable portion of the adjusting component is correspondingly connected to the at least one locating pin; and
wherein each locating pin slides independently within the corresponding locating structure, thereby driving a shape change of the corresponding adjustable portion.

3. The earmuff of the headphone according to claim 2, wherein each locating structure comprises a plurality of locating holes arranged along a radial direction of the earmuff, and the locating pin corresponding to the locating structure is disposed in one of the plurality of locating holes and is movable among the plurality of locating holes.

4. The earmuff of the headphone according to claim 1, wherein the case comprises:
a main body; and
at least one locating plate disposed on the main body;
wherein the at least one locating structure is correspondingly disposed in the at least one locating plate.

5. The earmuff of the headphone according to claim 1, wherein when the adjusting component comprises a plurality of the adjustable portions and a plurality of the fixed portions, and the plurality of adjustable portions and the plurality of fixed portions are alternately arranged with each other.

6. The earmuff of the headphone according to claim 1, wherein the adjusting component has two of the adjustable portions and two of the fixed portions, the two adjustable portions and the two fixed portions being alternately arranged with each other, the two adjustable portions are disposed on a long axis of the earmuff, and the two fixed portions are disposed on a short axis of the earmuff orthogonal to the long axis.

7. The earmuff of the headphone according to claim 1, wherein a cover layer of the earpad comprises an elastic portion disposed along an inner peripheral wall of the earpad, and the at least one fixed portion of the adjusting component is fixed to the elastic portion.

8. The earmuff of the headphone according to claim 7, wherein the elastic portion of the earpad has a hollow channel, and at least part of the adjusting component is inserted in the hollow channel.

9. The earmuff of the headphone according to claim 8, wherein the adjusting component is disposed in the hollow channel at a position of the at least one fixed portion.

10. The earmuff of the headphone according to claim 1, further comprising:
an outer case combined with the case; and
a sound-generating unit disposed in a space formed between the outer case and the case.

11. A headphone, comprising:
two earmuffs, each earmuff comprising:
a case having at least one locating structure;
an earpad disposed on the case; and
an adjusting component disposed between the earpad and the case, wherein the adjusting component comprises at least one adjustable portion and at least one fixed portion, the at least one adjustable portion is correspondingly and movably disposed on the at least one locating structure of the case, and the at least one fixed portion is fixed to the earpad; and
a headband connected with the two earmuffs.

12. The headphone according to claim 11, wherein each earmuff further comprises:
at least one locating pin respectively slidably corresponding to the at least one locating structure;
wherein the at least one adjustable portion of the adjusting component is correspondingly connected to the at least one locating pin; and
wherein each locating pin slides independently within the corresponding locating structure, thereby driving a shape change of the corresponding adjustable portion.

13. The headphone according to claim 11, wherein in each earmuff, each locating structure comprises a plurality of locating holes arranged along a radial direction of the earmuff, and the locating pin corresponding to the locating structure is disposed in one of the plurality of locating holes and is movable among the plurality of locating holes.

14. The headphone according to claim 11, wherein in each earmuff, a cover layer of the earpad comprises an elastic portion disposed along an inner peripheral wall of the earpad, and the at least one fixed portion of the adjusting component is fixed to the elastic portion.
